(19) United States
(12) Patent Application Publication
(10) Pub. No.: US 2004/0028822 A1
(43) Pub. Date: Feb. 12, 2004

(54) Continuous process for applying a tricoat finish on a vehicle

(76) Inventors: Wilfried Dutt, Wermelskirchen (DE); Walter C. Meyer, Rochester Hills, MI (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/216,256

(22) Filed: Aug. 8, 2002

(51) Int. Cl. B05D 3/02; B05D 1/36; B05D 1/02

(52) U.S. Cl. 427/385.5; 427/407.1; 427/421

(57) ABSTRACT

A process and materials for coating motor vehicles with flake containing tricoat color finishes in a wet-on-wet-on-wet system on a continuously moving paint application line.

### BACKGROUND OF THE INVENTION

This invention is directed to a process and materials for coating a substrate with a flake or other effect pigment containing tricoat color finish in a continuous wet-on-wet application process. In particular, this invention is directed to a process for coating motor vehicles such as automobiles or trucks during their original manufacture with tricoat colors in a continuous, single pass, wet-on-wet-on-wet vehicle paint application process.

Automobile and truck bodies are treated with multiple layers of coatings which enhance the appearance of the vehicle and also provide protection from corrosion, scratch, chipping, ultraviolet light, acid rain and other environmental conditions. Base coat/clear coat finishes for automobiles and trucks have been commonly used over the past two decades. Kurauchi et al U.S. Pat. No. 4,728,543 issued Mar. 1, 1988 and Benefiel et al U.S. Pat. No. 3,639,347 issued Feb. 1, 1972 show the application of a clear coat to a color coat or basecoat in a “wet on wet” application, i.e., the clear coat is applied before the base coat is completely cured. Nowadays, it is popular to apply liquid solvent borne clear coats over waterborne basecoats, as shown in Backhouse U.S. Pat. No. 4,403,003 issued Sep. 6, 1983, to meet current low overall solvent emission standards.

The desire for even more unique and attractive color styling has led the auto industry to utilize a three coat layering system. This includes a first colored basecoat layer (e.g., white), then a second semi-transparent (not opaque) color coat which contains a flake (e.g., pearl flake) and finally, a third clear coat layer. The clear coat provides protection for the two color coats and improves the appearance of the overall finish including gloss and distinctness of image. This type of finish has become known throughout the industry as a “tricoat” finish.

The methods to accomplish this tricoat finish can vary widely. Oftentimes, the first two colored basecoat layers are applied as liquid basecoats. A major challenge that faces all automotive manufacturers is how to rapidly dry these coatings in a typical continuous in-line auto or truck paint application process, with minimal capital investment in spray booth space and drying zones.

Various ideas have been proposed to solve this capacity problem. One approach is to apply a full basecoat plus clearcoat on the vehicle and bake, then send the vehicle through the painting process a second time for a semi-transparent color coat plus clearcoat. This two step process yields excellent color and paint workability, but, removes one unit of painting capacity for every unit double painted. A second approach that avoids double painting the vehicle includes using a colored primer (such as white) as the first color coat and then painting the semi-transparent basecoat and final clearcoat in the typical continuous in-line paint process. Although this approach has the advantage of eliminating the production bottleneck, it also eliminates the value of the first basecoat film properties and doesn't allow the easy handling of normal defects in the primer (for e.g., sanding of primer defects). A third approach used to minimize the production loss from double painting a vehicle is to paint the vehicles in a modular paint shop where the car stops and spends more time in the spray booth so the three layers can be successfully applied. This still causes the loss of some production capability and becomes more significant when this color family becomes more popular.

In addition to the above processing problems, today's vehicle manufacturers are responding to environmental concerns with increased substitution of waterbased materials in place of solvent based materials. This places an additional burden on wet-on-wet applications to provide longer drying times for the necessary water evaporation. To date no manufacturer has been successful with differently pigmented waterbased color coats applied on continuous coating lines, which are found in nearly all auto or truck assembly plants throughout the world.

Therefore, there is still a need for a continuous process that can accomplish the same “tricoat” style of colors in a single wet-on-wet-on-wet pass with waterbased color coats and waterbased, solvent based or powdered clear coats.

### SUMMARY OF THE INVENTION

The present invention is directed to a process for coating an automotive substrate with a tricoat finish on a continuously moving paint application line, comprising the steps of:

(a) applying a first waterborne basecoat composition to a surface of an automotive substrate;

(b) directly thereafter applying a second semi-transparent waterborne basecoat composition containing one or more flake or other effect pigments;

(c) subjecting the combined basecoats to an intermediate drying step;

(d) applying over said basecoat layer, a clear coat composition; and

(e) curing the tricoat finish together in a final bake;

wherein the automotive substrate is in continuous movement throughout the paint application process.

The invention is based on the discovery that a first waterborne basecoat composition can be formulated that possesses sufficient holdout or resistance to strike-in and intermixing of the subsequent flake containing basecoat within 30-300 seconds of application of the first coat. This enables the second flake-containing basecoat to be rapidly applied over the first differently pigmented basecoat wet-on-wet, without interfering with the proper flake orientation and color uniformity of the overall finish. By the term “wet-on-wet”, it is meant that the second base coat is applied to the first base coat without a curing or drying step between the different basecoats. This, in turn, allows all three coats of the tricoat finish to be applied wet-on-wet-on-wet in a single pass in existing basecoat/clearcoat painting facilities without the need to reconfigure or slow down or extend the painting time.

The claimed invention further includes waterborne basecoat compositions usable in the present process that have sufficient hold-out or resistance to strike-in and intermixing within 30-300 seconds of application and a coated automotive substrate prepared according to the present process.

### BRIEF DESCRIPTION OF THE DRAWINGS

FIG. 1A is a general flow diagram of a standard basecoat/clearcoat application process used nowadays to produce basecoat/clearcoat finishes of automotive quality and appearance.

FIG. 1B is a general flow diagram of a prior art, tricoat application process that requires double processing of a vehicle.

FIG. 1C is a general flow diagram of the continuous tricoat application process according to the present invention.

FIG. 2 is a side elevational schematic diagram of the tricoat application process of FIG. 1C.

### DETAILED DESCRIPTION OF THE PREFERRED EMBODIMENTS

The present invention relates to the application of tricoat finishes on automotive substrates during their original manufacture on an automotive assembly line. More particularly, it provides a process for coating the exterior of an automotive substrate such as an auto or truck body or parts thereof with a tricoat finish wet-on-wet-on-wet in a single pass on a continuously moving in-line paint application line. By “continuously moving”, it is meant that the substrate is in continuous movement along the application line during the painting process. This process involves the use of waterborne basecoats that have the ability to hold-out or prevent intermixing when a second pigment flake containing waterborne basecoat is applied in a wet-on-wet process, so that the second flake containing basecoat can be applied 30 to 300 seconds after application, without the need for an intermediate bake. This enables the present invention to run in existing basecoat/clearcoat painting facilities without the need to reconfigure, (e.g., spur) or slow down the paint line or extend the painting time.

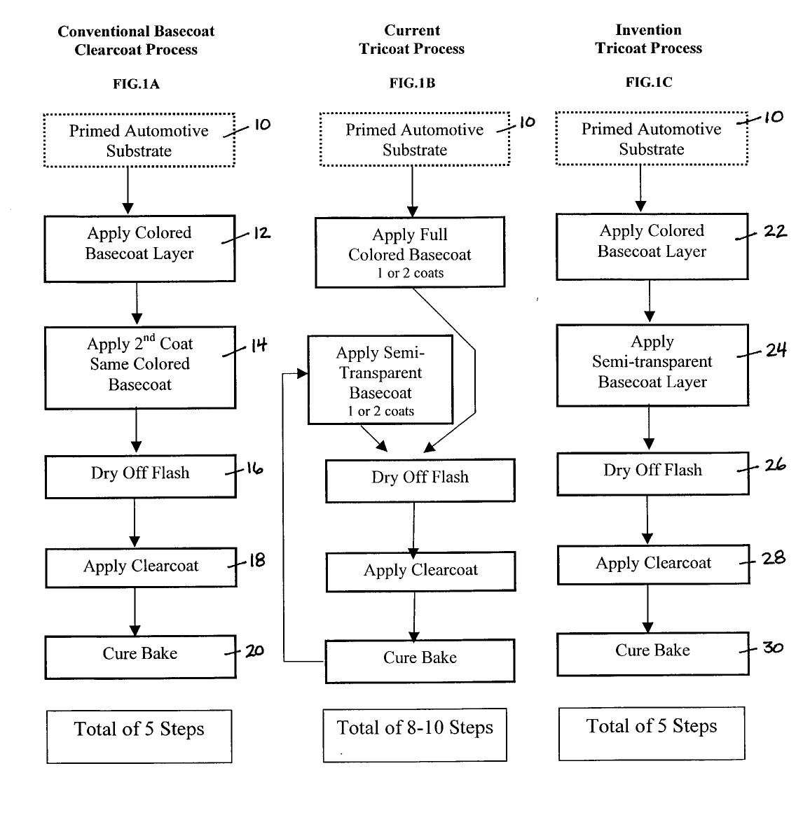

To demonstrate how the present invention can be run on existing basecoat/clearcoat vehicle paint lines, a traditional single pass basecoat/clearcoat continuous paint application process is shown in FIG. 1A. In this process, an automobile steel panel or plastic substrate 10, which may be previously primed or otherwise treated as conventional in the art, is moved to a continuous in-line basecoat/clearcoat application area. A basecoat color is applied first to the surface of the substrate typically in two steps 12, 14 separated by 30-300 seconds between the first and second coats. Typical basecoats comprise a mixture of pigments, which may include special effect flake pigments, film-forming binder polymers and optionally crosslinking agents and others additives and solvents necessary for application. When the basecoats are waterbased systems, as is conventional in the art, it is also necessary to have a forced drying step 16 for removal of some of the water and any other organic liquid diluent contained therein before the clearcoat is applied. A clearcoat is then applied in step 18 to the semi-dried pigmented basecoat. This is still commonly called a wet-on-wet process because the basecoat is not completely dried or cured before application of the clearcoat. The coated substrate is then baked in step 20 under standard conditions to simultaneously cure the basecoat and clearcoat composition on the surface and produce a finish of automotive quality and appearance.

According to the present invention, a tricoat finish of automotive quality and appearance can now be applied in a single pass using existing basecoat/clearcoat continuous paint application lines described above. This can be easily seen by a side-by-side comparison of FIGS. 1A and 1C. As shown in FIG. 1C, in the first step of the process of this invention, a first basecoat color (or “groundcoat”) is applied to the surface of the automotive substrate 10 in the standard first basecoat application station 22. This is followed 30-300 seconds later by the second semi-transparent flake or other effect pigment containing basecoat color, which is sprayed in the standard second basecoat application station 24. As can be seen, this process accordingly takes advantage of the two existing basecoat zones without the need to reconfigure the line. In order to enable this unique wet-on-wet application of these two differently pigmented waterbased basecoat layers and thus continuous processing of the tricoat finish, the first and second basecoats must be formulated to have acceptable hold-out or resistance to intermixing after about 30 seconds to 5 minutes at ambient conditions between coats, preferably after 1 to 4 minutes at ambient conditions. This allows a wet-on-wet-on-wet application of the first and second basecoats and clearcoat without sacrificing good control of the orientation of the flake or effect pigments and interfering with the special color effect (i.e. brightness, flop) or color uniformity of the overall tricoat finish.

The first basecoat (or groundcoat) composition employed in the present invention is a pigmented waterborne composition of appropriate color and hiding. Preferably, the first waterborne basecoat is a crosslinkable composition comprising a film-forming material or binder, volatile material, and pigment. The film-forming binder preferably contains at least one water-compatible film forming material such as an aqueous microgel, polyol polymer, or mixture thereof and at least one crosslinking agent such as an aminoplast resin.

Suitable microgels that can be used to form the basecoat composition include crosslinked polymer microparticle aqueous dispersions such as disclosed in Backhouse U.S. Pat. No. 4,403,003 issued Sep. 6, 1983 and Backhouse U.S. Pat. No. 4,539,363 issued Sep. 3, 1985, both hereby incorporated by reference. The microgel preferably contains appropriate functional groups, such as hydroxy groups, whereby they can become crosslinked, after application of the composition to the substrate by means of a crosslinking agent, e.g., the amino resin.

The aqueous polymer microgel suitable for use in this invention may be composed of various types of crosslinked polymers. Of particular interest for the purposes of this invention are crosslinked acrylic microgel particles. Preparation of such acrylic microgels may be carried out by methods which are well known and routinely practiced by those of ordinary skill in the art. Typically, the microgels are acrylic addition polymers mainly derived from one or more alkyl acrylates or methacrylates, optionally together with other ethylenically unsaturated copolymerizable monomers like styrene and vinyl esters. Suitable alkyl acrylates or methacrylates include, without limitation, alkyl acrylates and methacrylates each having 1-18 carbon atoms in the alkyl group. Since the polymer is required to be formed with internal crosslinking, there may be included in the monomers from which the polymer is derived a minor proportion of a monomer which is polyfunctional with respect to the polymerization reaction, such as ethylene glycol dimethacrylate, allyl methacrylate or divinylbenzene. Alternatively, there may be included in the monomers minor proportions of two other monomers carrying pairs of functional groups which can be caused to react with one another either during or after polymerization, such as epoxy and carboxyl (as for example, in glycidyl methacrylate and methacrylic acid), anhydride and hydroxyl, or isocyanate and hydroxyl. There also is preferably included in the monomers from which the microgel is derived minor amounts of a hydroxy containing monomer for crosslinking purposes after application of the composition to the substrate from the following group: hydroxy alkyl acrylates or methacrylates, or any mixtures of other ethylenically unsaturated hydroxy. Acid functional monomers such as acrylic acid or methacrylic acid are also preferably included in the monomer mix to ionically stabilize the crosslinked microparticles in the aqueous dispersion medium by converting such groups to a suitable salt by reaction with a base, such as dimethylaminoethanol, dissolved in the aqueous medium. Alternatively, the required stability in the aqueous medium can be achieved by using an acrylate or methacrylate monomer containing basic groups, for example, dimethylaminoethyl methacrylate which are neutralized with a suitable acid, such as lactic acid. Stability in aqueous medium can also be achieved through the use of surfactants or macromonomers which contain water soluble nonionic stabilizers such as materials which contain polyethylene glycol structures. By aqueous medium, it is meant either water alone or water admixed with a water-miscible organic co-solvent such as an alcohol. The crosslinked microgel particles so produced are provided in colloidal dimensions. The microgel particles that are particularly useful in this invention generally have a colloidal size from about 80 to 400 nanometers, in diameter, preferably from about 90 to 200 nanometers.

Suitable polyols useful for preparing the basecoat composition include water-compatible acrylic, polyester, polyurethane, polyether, or other polyol having a hydroxyl number of 50-200, as are conventional in the art. Suitable crosslinking materials include aminoplast resins soluble or partially in the aqueous medium of the composition, such as melamine-formaldehyde condensates and in particular alkylated (e.g., methylated, butylated) melamine-formaldehyde condensates. Other contemplated crosslinking materials are alkylated urea formaldehyde condensates, benzoquanamine formaldehyde condensates and blocked polyisocyanates or compatible mixtures of any of the forgoing. Additional water-compatible film-forming and/or crosslinking polymers may be included in the basecoat employed in the present invention. Examples include water compatible acrylics, polyurethane, epoxies, or mixtures thereof. Alternatively or in addition to the film-forming polymers mentioned above, film-forming filler materials such as polyether glycols of low volatility, for e.g., low molecular polypropylene and/or polyethylene glycol, can be used to fill the voids formed by the microgel particles upon drying and improve the physical properties of the resulting film or finish. These oligomeric substances can be converted to high molecular weight polymer, after application of the basecoat composition, by linking them through their hydroxyl groups or other reactive groups to the aminoplast or other crosslinking resin.

One typically useful first basecoat, in addition to pigments, comprises by weight of binder solids, aqueous microgel for rheology control from about 30-80%, preferably 45-70%, such as but not limited to the crosslinked acrylic microparticle aqueous dispersions disclosed in aforementioned U.S. Pat. No. 4,403,003, water-soluble or partially water-soluble aminoplast resin, preferably a methylated melamine formaldehyde, from 10-35%, preferably 15-25%, water dispersible polyester polyol resin from about 0-30%, polyurethane polyol aqueous dispersion from 0-25%, preferably 5-15%, water soluble polyether filler from 0-10%, water-soluble acid catalyst from about 0-2%, such as but not limited to a volatile amine blocked sulfonic acid catalyst, to promote melamine or other crosslinking reaction. The composition also includes 0.1-1.5%, preferably 0.2-1%, based on the weight of the total composition, sheet silicate particle, such as those disclosed in Berg et al. U.S. Pat. No. 5,198,490 issued Mar. 30, 1993, to help give the desired holdout or resistance to strike-in and intermixing.

The overall solids content of the first basecoat composition typically ranges from about 20 to 70% by weight (for e.g., a white basecoat typically has 30-50% solids by weight).

A variety of pigments and optionally special effect flakes or other effect pigments may be employed in the first basecoat, as would be apparent to those skilled in the art. The first basecoat, however, is typically a “straight-shade” or “solid color” coating that has no visible flop or two tone metallic effect and primarily contains colored pigments other than flake.

Typical colored pigments that can be used include the following: metal oxides such as titanium dioxide, zinc oxide, iron oxides of various colors, carbon black, filler pigments such as talc, china clay, barytes, carbonates, silicates and a wide variety of organic colored pigments such as quinacridones, phthalocyanines, perylenes, azo pigments, indanthrone blues, carbazoles such as carbozole violet, isoindolinones, isoindolones, thioindigo reds, benzimidazolinones, diketo-pyrrolo-pyrroles (DPP). Minor amounts of special effect flakes such as aluminum flakes, copper bronze flakes, pearlescent flakes, and the like, and optional other effect pigments such as vacuum metalized flakes, holographic flakes, glass spheres, glass flakes, other non-flake effect pigments including micro titanium dioxide pigments and Graphitan® pigments, and higher degree effect pigments including, for instance, Chromaflair®, Variochrome®, and Helicone® pigments, can also be included in the first basecoat to impart the desired color effect and hiding. When the coating contains metallic pigments, agents which inhibit the reaction of the pigments with water may be added. Typical inhibitors are phosphated organic materials such as phosphoric acid and other materials as described in U.S. Pat. No. 4,675,358. The specific pigment to binder ratio can vary widely so long as it provides the requisite hiding at the desired film thickness and application solids. The pigments can be introduced into the basecoat by first forming a mill base or pigment dispersion with any of the aforementioned polymers used in the coating composition or with another compatible polymer or dispersant by conventional techniques, such as high speed mixing, media milling, sand grinding, ball milling, attritor grinding or two/three roll milling. The pigment dispersion is then blended with the other constituents used in the coating composition.

The second basecoat employed in this invention is a differently pigmented composition that is formulated to be semi-transparent and contains one or more special effect flake or other effect pigments, and optionally other colored pigments, which give the desired color effect. By the term “special effect flakes”, it is meant pigment flakes that have the ability to impart visible flop or two tone effect to a coating film.

Preferred second waterborne basecoats similar to the first basecoats also contain in the binder an aqueous microgel, such as but not limited to the crosslinked microparticle dispersions disclosed in aforementioned U.S. Pat. No. 4,403,003, optional polyol polymer, and an amino such as melamine crosslinking agent. Any of the microgels, polyols, and crosslinking resins listed above for use in the first basecoat can be used in the second basecoat. Additional water-compatible film-forming and/or crosslinking polymers may also be included. Examples include water compatible acrylics, polyurethane, epoxies, or mixtures thereof. As described above, crosslinkable polyether fillers can also be used.

One typically useful second basecoat, in addition to special effect flakes and pigments, comprises by weight of binder solids, aqueous microgel for rheology control from about 30-80%, preferably 50-75%, water-soluble or partially water-soluble aminoplast resin, preferably a methylated melamine formaldehyde, from about 10-35%, preferably 15-25%, water dispersible polyester polyol resin from about 0-30%, polyurethane polyol aqueous dispersion from about 0-35%, preferably 15-25%, water-soluble polyether filler from 0-10%, blocked acid catalyst from about 0-2%, such as but not limited to amine blocked sulfonic acid catalyst, to promote melamine or other crosslinking reaction. The composition also includes 0.1-1.5%, preferably 0.3-1%, based on the weight of the total composition, sheet silicate particle to help give the desired holdout or resistance to strike-in and intermixing. As with the first basecoat composition, the amount of aqueous microgel and sheet silicate employed in the second basecoat is critical to the practice of this invention.

The overall solids content of the second basecoat composition typically ranges from about 10 to 35% by weight (for e.g., a pearlcoat typically has 15-25% solids by weight).

A variety of special effect flakes and other effect pigments, and optionally other colored pigments, may be employed in the second basecoat, as would be apparent to those skilled in the art. The second basecoat, however, is typically formulated as a semi-transparent flake-containing coating that has visible flop or two tone effect.

Typical pigments in the basecoat composition include the following: flake pigments such as aluminum flake, copper bronze flakes, pearlescent flakes, as well as any of the other effect pigments listed above for use in the first basecoat, metal oxides such as titanium dioxide, zinc oxide, iron oxides of various colors, carbon black, and a wide variety of organic colored pigments such as quinacridones, phthalocyanines, perylenes, azo pigments, indanthrone blues, carbazoles such as carbozole violet, isoindolinones, isoindolones, thioindigo reds, benzimidazolinones, diketo-pyrrolo-pyrroles (DPP) and the like. As with the first basecoat composition, when the coating contains metallic pigments such as aluminum flakes, agents which inhibit the reaction of the pigments with water may be added. Typical inhibitors are phosphated organic materials such as phosphoric acid, and the like. The specific pigment to binder ratio can vary so long as it provides the requisite color effect and hiding at the desired film thickness and application solids. The pigments may be introduced into the second basecoat as in the first basecoat composition by first forming a mill base or pigment dispersion with any of the aforementioned polymers used in the coating composition or with another compatible polymer or dispersant by conventional techniques, such as mixing/slurrying (i.e., for flakes), high speed mixing, media milling, sand grinding, ball milling, aftritor grinding or two/three roll milling. The pigment dispersion is then blended with the other constituents used in the coating composition.

Both basecoat compositions employed in the present invention may also include other conventional formulation additives such as wetting aids, surfactants, defoamers, UV fortifiers, and rheology control agents, such as fumed silica, alkali swellable emulsions, associative thickeners, or water compatible cellulosics. Both basecoat compositions employed in this invention also include volatile materials such as water alone or water in admixture with conventional water-miscible organic solvents and diluents, to disperse and/or dilute the above mentioned polymers and facilitate formulation and spray application. Typical water-miscible organic co-solvents and diluents include toluene, xylene, butyl acetate, acetone, methyl isobutyl ketone, methyl ethyl ketone, methanol, isopropanol, butanol, butoxyethanol, hexane, acetone, ethylene glycol, monoethyl ether, VM and P naptha, mineral spirits, heptane and other aliphatic, cycloaliphatic, aromatic hydrocarbons, esters, ethers and ketones and the like. However, in a typical basecoat for this invention, water is used as the major diluent. Amines such as alkanolamine can also be used as a diluent.

For additional examples of the various constituents that may be selected for use in the waterborne basecoat compositions employed herein, reference can be made to any of the aforementioned U.S. Pat. Nos. 4,403,003, 4,539,363, and 5,198,490, all previously incorporated by reference herein.

The nature of the clearcoat composition employed in the process of the present invention is in no way critical. Any of a wide variety of commercially available automotive clearcoats may be employed in the present invention, including standard solvent borne, waterborne or powdered clears. High solids solvent borne clear coats which have low VOC (volatile organic content) and meet current pollution regulations are generally preferred. Typically useful solventborne clearcoats include but are not limited to 2K (two component) systems of polyol polymers crosslinked with isocyanate and 1K systems of acrylic polyol crosslinked with melamine or 1K acrylosilane systems in combination with polyol and melamine. Epoxy acid systems can also be used. Such finishes provide automobiles and trucks with a mirror-like exterior finish having an attractive aesthetic appearance, including high gloss and DOI (distinctness of image). Suitable 1K solvent borne acrylosilane clearcoat systems that can be used in the process of the present invention are disclosed in U.S. Pat. No. 5,162,426, hereby incorporated by reference. Suitable 1K solvent borne acrylic/melamine clearcoat systems are disclosed in U.S. Pat. No. 4,591,533, hereby incorporated by reference.

According to the present invention, the three coating compositions described above can be applied by conventional techniques such as spraying, electrostatic spraying, high rotational electrostatic bells, and the like. The preferred techniques for applying all three coatings are air atomized spraying with or without electrostatic enhancement, and high speed rotational electrostatic bells, since these techniques are typically employed in a continuous paint application process.

Useful substrates that can be coated according to the process of the present invention include a variety of metallic and non-metallic substrates such as plastic substrates, and combinations thereof. Useful metallic substrates that can be coated according to the process of the present invention include unprimed substrates or previously painted substrates, cold rolled steel, phosphatized steel, and steel coated with conventional primers by electrodeposition. Useful plastic materials include polyester reinforced fiberglass, reaction-injection molded urethanes, partially crystalline polyamides, and the like or mixtures thereof and their associated primers

Preferably, the substrates are used as components to fabricate automotive vehicles, including but not limited to automobiles, trucks, and tractors. The substrates can have any shape, but are usually in the form of automotive body components such as bodies, hoods, doors, fenders, bumpers and/or trim for automotive vehicles. The invention is most useful in the context of coating automotive bodies and components thereof traveling in continuous movement along an automotive assembly line.

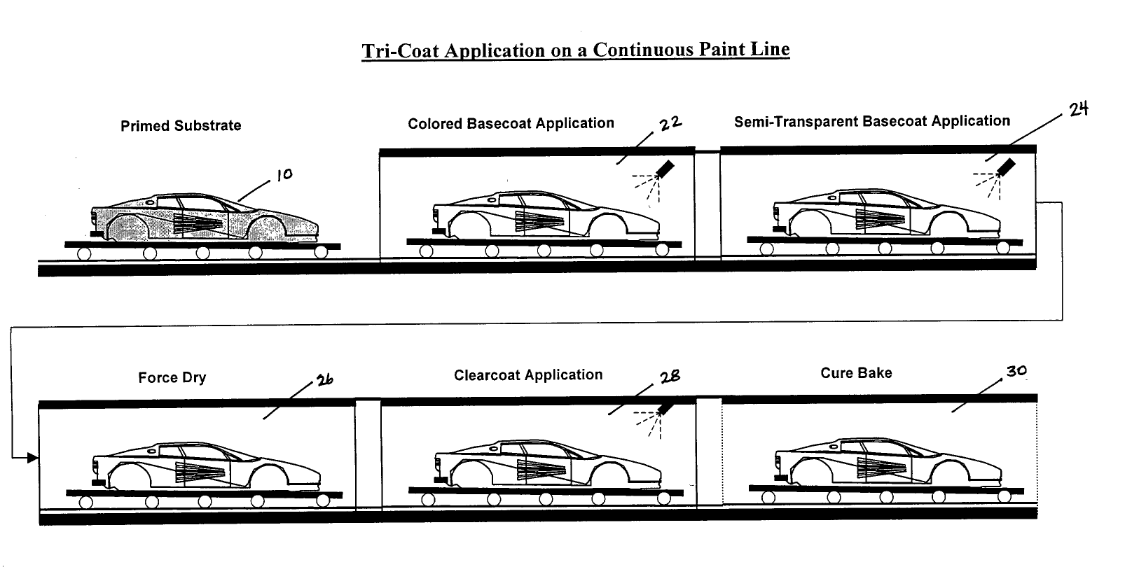

Referring now to FIG. 1C, the entire process of this invention will now be described in the context of coating an automotive substrate 10. Prior to treatment according to the process of this invention, the substrate (as shown in the drawing) may be previously primed or otherwise treated as conventional in the art. In the first operational step 22 of the process, the first liquid waterborne basecoat or groundcoat composition is applied to the surface of the primed automotive substrate (such as the automobile body shown in FIG. 2), preferably over an electrodeposited coating or primer surfacer. The first liquid basecoat can be applied to the surface of the substrate in this step by any suitable coating process well known to those skilled in the art, such as by any of the techniques described above. The method and apparatus for applying the liquid basecoat composition to the substrate is determined in part by the configuration and type of substrate material.

After application of the first basecoat, the process of the present invention includes a second step 24 of directly applying the second liquid waterborne semi-transparent flake or other effect pigment containing basecoat composition (usually a pearlcoat) over the first waterborne basecoat composition, as the vehicle travels along the assembly line, by means of a wet-on-wet application, i.e., the second basecoat is applied to the first basecoat without curing or completely drying the first basecoat. The second liquid basecoat can be applied to the surface of the substrate in this step by any suitable coating process known to those skilled in the art, such as by any of the techniques described above. In the present process, the second basecoat is applied within about 30 seconds to 5 minutes of the first basecoat application, preferably within about 1-4 minutes of application, which is the typical dwell time in a conventional basecoat spray booth for existing basecoat/clearcoat systems.

Therefore, unlike conventional tricoat processes (as shown in FIG. 1B) that involve the use of differently pigmented waterborne basecoats, an intermediate drying step or bake is not needed before applying a subsequent basecoat thereover. By controlling the rate at which the first basecoat can achieve holdout, flake misalignment and flaws in the appearance of the flake containing basecoat and clearcoat can be minimized.

After applying the second basecoat, the process of the present invention preferably includes a third step 26 of subjecting the combined basecoat layers to a drying step to volatilize at least a portion of the volatile materials from the liquid coating compositions and set the basecoats on the substrate. By set, it is meant that the basecoat is dried sufficient so that it is not disturbed or marred (waved or rippled) by air currents which may blow past the basecoated surface. The volatilization or evaporation of volatiles from the basecoat can be carried out in open air, but is preferably carried out in a forced drying chamber as shown in FIG. 2 in which heated air (40-100° C.) or dehydrated air is circulated at low velocity to minimize airborne particle contamination.

This step 26 is commonly referred to as a flash drying step. The automobile body is positioned at the entrance to the drying chamber and slowly moved therethrough in assembly-line manner at a rate which permits the volatilization of the basecoat as discussed above. The rate at which the auto is moved through the drying chamber depends in part upon the length and configuration of the drying chamber. Overall, this intermediate drying step may last for 30 seconds to 10 minutes, although in normal assembly plants, this step should take from about 2-5 minutes.

The dried basecoat that is formed upon the surface of the automobile body is dried sufficiently to enable application of the clear topcoat such that the quality of the topcoat will not be affected adversely by further drying of the basecoat. Preferably, the dried basecoats, after application to the surface of the substrate, form a multilayer film which is substantially uncrosslinked, i.e., is not heated to a temperature sufficient to induce significant crosslinking and there is substantially no chemical reaction between the film-forming polymers and crosslinking material therein. If too much water is present, the topcoat can crack, bubble or pop during drying of the topcoat as water vapor form the basecoat attempts to pass through the topcoat.

Referring again to FIGS. 1C and 2, the process of the present invention comprises a next step 28 of applying a liquid or powder clear topcoat composition over the dried composite basecoat layers. The clearcoat can be applied by any of the methods described above. With liquid clearcoats, it has become customary, particularly in the auto industry, to apply the clear topcoat over a basecoat by means of a wet-on-wet application, i.e., the topcoat is applied to the basecoat without curing or completely drying the basecoat. As indicated above, the clearcoat is preferably applied over a basecoat which has been dried, preferably flash dried for a short period, before the clearcoat is applied. This is still commonly called a wet-on-wet process because the basecoat is not completely dried or cured. Although less preferred, the basecoat can be cured, if desired, before the clear coat is applied.

Following the application of the clearcoat, the process of the present invention preferably comprises a curing step 30 in which the coated substrate is heated for a predetermined time period to allow simultaneous curing of the base and clear coats. The curing step can be carried out using hot air convection drying, infrared radiation, or a combination thereof. The three layer composite coating composition is preferably baked at 100-150° C. for about 15-30 minutes to form a cured tricoat finish on the substrate. As used herein, cured means that the crosslinkable components of the coatings are substantially crosslinked. By the term substantially crosslinked, it is meant that, although at least most curing has occurred, further curing may occur over time.

The process of the invention may also include a subsequent cooling step (not shown) to cool the tricoat finish to ambient temperatures before the vehicle is further worked on during its manufacture.

The thickness of the dried and cured composite tricoat finish is generally about 40-150 μm (1.5-6 mils) and preferably 60-100 μm (2.5-4 mils). The basecoats and clearcoat are preferably deposited to have thicknesses of about 3.0-40 μm (0.1-1.6 mils) and 25-75 μm (1.0-3.0 mils), respectively.

The following Examples illustrate the invention. All parts and percentages are on a weight basis unless otherwise indicated.

### EXAMPLE 1

### Basecoat Preparation

The following premixes were prepared:

A. Preparation of White Pigment Dispersion

The following pigment slurry was prepared, 14.5 g of de-ionized water, 1.0 g of acrylic microgel dispersion (as described in aforementioned U.S. Pat. No. 4,403,003, Example 4), 30.5 g butoxyethanol, 7.5 g Cymel® 303 (alkylated melamine formaldehyde resin), 2.0 g of 10% dimethylethanol amine solution and 1.0 g Surfynol® 104 (surfactant). The above components were mixed together, 31.5 g of Ti02 was added and the resulting slurry was then pre-dispersed using a Cowles blade. The mixture was then ground in a horizontal beadmill until the desired particle size of less than 0.5 micron was achieved before it was stabilized by adding a letdown solution containing 1.0 g of acrylic microgel dispersion (as described above) and 12 g of de-ionized water.

B. Preparation of Yellow Pigment Dispersion

The following pigment slurry was prepared, 39.0 g of de-ionized water, 1.0 g of acrylic microgel dispersion (as described in U.S. Pat. No. 4,403,003, Example 4), 30.5 g butoxyethanol, 7.5 g Cymel® 303, 2.0 g of 10% dimethylethanol amine solution and 1.0 g Surfynol® 104. The above components were mixed together, 20.0 g of Bayferrox® 3910 (yellow iron oxide) was added and the resulting slurry was then pre-dispersed using a Cowles blade. The mixture was then ground in a horizontal beadmill until the desired particle size of less than 0.5 micron was achieved.

C. Preparation of Red Pigment Dispersion

The following pigment slurry was prepared, 7.0 g of de-ionized water, 10.0 g of acrylic microgel dispersion (as described in U.S. Pat. No. 4,403,003, Example 4), 10.0 g butoxyethanol, 7.0 g Cymel® 303, 0.5 g of 10% dimethylethanol amine solution and 1.0 g Surfynol® 104. The above components were mixed together, 40.0 g of Bayferrox® 130M (red iron oxide) was added and the resulting slurry was then pre-dispersed using a Cowles blade. The mixture was then ground in a horizontal beadmill until the desired particle size of less than 0.5 micron was achieved before it was stabilized by adding a letdown solution containing 10.0 g of acrylic microgel dispersion (as described above) and 14.5 g of de-ionized water.

D. Preparation of Effect Pigment Concentrate (Xirallic®, Flake Pigment)

15.0 g of butoxyethanol was mixed with 10.0 g of de-ionized water and then 17.0 g of Xirallic® Cristal Silver SW was added under stirring. This slurry was kept under agitation while 50.0 g of acrylic microgel dispersion (as described under A. above) was added. This mixture was stirred until a homogeneous, smooth slurry was produced, before the final addition of 0.3 g of a 10% dimethylethanol amine solution and 7.7 g of de-ionized water.

E. Preparation of Effect Pigment Concentrate (Iriodin®, Mica Flake)

15.0 g of butoxyethanol was mixed with 10.0 g of de-ionized water and then 17.0 g of Iriodin® 9121 SW was added under stirring. This slurry was kept under agitation while 50.0 g of acrylic microgel dispersion (as described under A. above) was added. This mixture was stirred until a homogeneous, smooth slurry was produced., before the final addition of 0.3 g of a 10% dimethylethanol amine solution and 7.7 g of de-ionized water.

F. Preparation of Rheology Base

A homogeneous blend of the following was prepared by mixing together and stirring: 47.5 g of acrylic microgel dispersion (as described under A. above), 2.0 g of buthoxyethanol and 0.5 g of Surfynol 104. 50.0 g of a 3% Laponite® RD (layered silicate) solution in de-ionized water was added under stirring and homogenized and dispersed under a Cowles blade.

### EXAMPLE 2

### Preparation of Waterborne White Solid Color Basecoat (“Groundcoat”) Composition

A waterborne white solid color basecoating composition was prepared by mixing together the following ingredients under constant agitation in the order stated:

Acrylic microgel dispersion as described in (1,A.), above—23.9 parts. Cymel® 303—0.6 parts. White pigment dispersion as described in (1,A.), above—53.9 parts. Yellow pigment dispersion as described in (1,B.), above—0.2 parts. Red pigment dispersion as described in (1,C.), above—0.1 parts. Rheology base as described in (1,F.), above—14 parts. Surfynol® 104, 1.0 parts. The desired viscosity (1000-4000 mpa*s at shear rate D=1 sec⁻¹) and the desired pH (pH 8.2-8.5) are adjusted with an appropriate combination of de-ionized water to lower viscosity, a 3% pre-neutralized solution of Acrysol ASE 60® (polyacrylic acid thickener) in de-ionized water to raise viscosity and a 10% dimethylethanol amine solution in de-ionized water to raise the pH, in such a way that the amount of these products used totals approximately 6.3 parts.

### EXAMPLE 3

### Preparation of Waterborne White Pearl Color Basecoat (“Pearlcoat”) Composition

A waterborne white pearl color basecoating composition was prepared by mixing together the following constituents under constant agitation in the order stated:

Acrylic microgel dispersion as described in (1,A.), above—12.2 parts. White pigment dispersion as described in (1,A.), above—0.3 parts. Cymel® 303—4.6 parts. Effect pigment concentrate “D” (Xirallic®) as described in (1,D.), above—13.1 parts. Effect pigment concentrate “E” (Iriodin®) as described in (1,E.), above—13.1 parts. Rheology base as described in (1,F.), above—10.0 parts. Buthoxyethanol, 3.3 parts. Surfynol® 104, 1.0 parts. The desired viscosity (2000-4000 mPas at shear rate D=1 sec units') and the desired pH (pH 8.2-8.5) are adjusted with an appropriate combination of de-ionized water, a 3% pre-neutralized solution of Acrysol ASE 60 in de-ionized water and a 10% dimethylethanol amine solution in de-ionized water, in such a way that the amount of these products used totals approximately 42.4 parts.

### EXAMPLE 4

### Solventborne Clearcoat

The clearcoat composition used for the examples was a baking clear, which is commercially available from Du Pont Performance Coatings (Standox), Christbusch 25, D-42285 Wuppertal/Germany, with following details: Standocryl 2K-HS Klarlack, 020-82497 (in the US, code number is Standox® HS Clear 14580), to be activated at a ratio of 2:1 with Standox 2K Haerter HS 15-25, 020-82403.

### EXAMPLE 5

### Continuous Application of 2 Different Basecoats and Clearcoat

A standard automotive metal car door has been processed and prepared with standard automotive pre-treatment and coatings systems, up to the primer/surfacer layer. It was then processed through a standard continuous basecoat/clearcoat automotive application line at a continuous line speed of approximately 4 meters/min, whereby the groundcoat (as described in example 2 above) was applied with an electrostatic bell at a flow rate of 120 cc/min. After 2 minutes under ambient conditions (i.e. 22° C., 60% r.h.), the pearlcoat (as described in example 3 above) was applied on top of the groundcoat, wet on wet, by pneumatic atomization with robots, at a flow rate of 520 cc/min. This was then followed by a standard force dry in a drying tunnel for approximately 5 minutes @ 60° C., after which, following the normal automotive line procedures, a commercial 2K isocyanate solvent based clearcoat (Standox® HS Clear 14580 commercially available from DuPont Company) was applied electrostatically, and the entire system was stoved @ 10 minutes/120° C. Film builds were as follows:

Goundcoat: 10-12 microns

Pearlcoat: 7-10 microns

Clearcoat: 40-45 microns

The system exhibited very good hold out. No sagging, film cracking or any other defects were observed. Appearance and general quality of the resulting finish was comparable to the quality of normal automotive colors run on continuous paint lines. A unique color effect is provided without degrading the appearance or mechanical properties.

Subsequent work under a variety of application conditions (groundcoat flowrate 70-160 cc/min; pearlcoat flowrate 400-600 cc/min; flash off time 1-5 minutes; ambient conditions) confirmed above outcome and exhibited a wide application window for this system, and the coatings thus obtained had similar excellent characteristics as that described above.

What is claimed:

1. A process for coating an automotive substrate with a tricoat finish on a continuously moving paint application line, comprising:
(a) applying a first waterborne basecoat composition to a surface of an automotive substrate;
(b) directly thereafter applying a second semi-transparent waterborne basecoat composition containing one or more effect pigments;
(c) subjecting the combined basecoats to an intermediate drying step;
(d) applying over said basecoat layer, a clear coat composition; and
(e) curing the three coat finish together in a final bake;
wherein the automotive substrate is in continuous movement throughout the paint application process.

2. The process of claim 1 wherein the time between the first and second basecoat is about 30 seconds to 5 minutes under ambient spray booth conditions.

3. The process of claim 1 wherein the clear coat is applied over the second basecoat without an intermediate baking (curing) step.

4. The process of claim 1 wherein both basecoat compositions used in the process each contain a mixture of aqueous acrylic microgel dispersion, optional polyol polymer, and melamine curing agent.

5. The process of claim 4 wherein both basecoat compositions each contain an effective amount of aqueous microgel dispersion and sheet silicate particle to provide holdout within 30 seconds to 5 minutes after application when exposed to ambient spray booth conditions.

6. The process of claim 5, wherein the aqueous microgel dispersion is composed of crosslinkable hydroxyl functional acrylic addition polymers derived mainly from one or more alkyl esters of acrylic acid or methacrylic acid.

7. The process of claim 1, wherein the clear coat is a solvent borne, waterborne or powdered clearcoat.

8. The process of claim 1 wherein the clear coat contains mixtures of polyols and melamine curing agents.

9. The process of claim 1 wherein the clear contains mixtures of polyols and isocyanate curing agents.

10. The process of claim 1 wherein the clear contains mixtures of polyols, acrylosilane, and melamine curing agents.

11. The process of claim 1, wherein said paint application line is a continuous in-line paint application line.

12. A process for coating an automotive substrate with a tricoat finish on a continuously moving paint application line, comprising:
(a) applying a first waterborne basecoat to a surface of an automotive substrate;
(b) after about 30-300 seconds, applying a second, semi-transparent waterborne basecoat containing one or more flake or other effect pigments wet-on-wet to the first waterborne basecoat;
(c) subjecting the combined colorcoats to an intermediate a drying step for a period of at least about 30 seconds at a temperature ranging from about 40 to 100° C. to volatilize at least a portion of the volatile material from the liquid basecoats;
(d) applying over said dried basecoat layer a clearcoat composition;
(e) simultaneously curing the basecoats and clear coat together to form a dried and cured tricoat finish on the substrate;
wherein the automotive substrate is in continuous movement throughout the paint application process.

13. The process of claim 1 or 12, wherein the first waterborne basecoat comprises a film-forming binder and an aqueous carrier, wherein the binder comprises by weight of binder solids, a mixture of
(i) an aqueous microgel from about 30-80% by weight;
(ii) a water-soluble or partially water-soluble melamine formaldeyde crosslinker resin from about 10-35% by weight;
(iii) water dispersible polyester polyol resin from about 0-30% by weight;
(iv) polyurethane polyol dispersion from about 0-25% by weight;
(v) blocked acid catalyst from about 0-2% by weight; and the composition further comprises
(vi) sheet silicate particles from about 0.1-1.5% wherein the amount of sheet silicate is based on the total weight of the composition;
(vii) one or more pigments, optionally effect pigments, to give the first basecoat appropriate color, hiding, and optionally effect; and
(viii) optional other additives as necessary to assure stability, wetting and application, and
wherein the second semi-transparent waterborne basecoat comprises a film-forming binder and an aqueous carrier, wherein the binder of the second basecoat comprises by weight of binder solids a mixture of
(i) an aqueous microgel from about 30-80% by weight;
(ii) a water-soluble or partially water-soluble melamine formaldeyde resin from about 10-35% by weight;
(iii) water dispersible polyester polyol resin from about 0-30% by weight;
(iv) polyurethane polyol dispersion from about 0-25% by weight;
(v) blocked acid catalyst from about 0-2% by weight; and the composition further comprises
(vi) sheet silicate particles from about 0.1-1.5% wherein the amount of sheet silicate is based on the total weight of the composition;
(vii) combination of pigments to give appropriate color and hiding containing at least one flake pigment to impart visible flop or two tone effect; and
(viii) optional other additives as necessary to assure stability, wetting and application.

14. The process of claim 1 or 12, wherein the first basecoat is a non-effect coat and the second basecoat is an effect coat.

15. The process of claim 14, wherein the second basecoat is a pearl coat.

16. The process of claim 1 or 12, wherein the first basecoat is an effect coat and the second basecoat is a different effect coat.

17. A liquid waterborne basecoat composition usable in the process of claim 1 that has sufficient holdout within 30-300 seconds after application when exposed to ambient temperatures.

18. An automotive substrate coated with a tricoat finish according to the process of claim 1 or claim 12.
